(19) United States
(12) Patent Application Publication
(10) Pub. No.: US 2008/0099444 A1
(43) Pub. Date: May 1, 2008

(54) Micro-Fabrication Method

(76) Inventors: Hiroaki Misawa, Hokkaido (JP); Saulius Juodkazis, Hokkaido (JP)

Correspondence Address: WENDEROTH, LIND & PONACK, L.L.P., 2033 K STREET N. W., SUITE 800, WASHINGTON, DC, 20006-1021, US

(21) Appl. No.: 10/585,845

(22) PCT Filed: Jan. 17, 2005
(86) PCT No.: PCT/JP05/00798

§ 371 Date: Oct. 18, 2006

(30) Foreign Application Priority Data
Jan. 16, 2004 (JP) 2004-9904

(51) Int. Cl. B29C 35/08

(52) U.S. Cl. 216/94

(57) ABSTRACT

A micro-fabrication method characterized by comprising the steps of applying a pulse laser beam to a plastic material to be processed exhibiting a glass phase transition by heating and having a heat-shrinkage to form laser-processed patterns on the surface of or in the above plastic material to be processed, and then heat-treating the plastic material to be processed at a temperature not lower than a glass transition temperature Tg to fine the formed patterns by heat-shrinkage.

### TECHNICAL FIELD

The present invention relates to a micro-fabrication method. More specifically, the present invention relates to a novel micro-fabrication method by a laser process, utilizing the glass phase transition, which dramatically contributes to the progress of the nano process technique.

### BACKGROUND ART

Conventionally, material processing using a laser beam has been carried out from the viewpoints of various purposes and applications so that the micro-fabrication by a laser beam has been discussed.

For example, Japanese Patent Application Laid-Open No. 2003-236929 proposes a technique of applying a pulse laser beam to a plastic material exhibiting a glass phase transition by heating for forming an induced structure part (pattern) therein. According to the technique, the ambient temperature at the time of the process by the pulse laser beam is more than the room temperature and less than the glass transition temperature Tg of the plastic material to be processed (Tg—30° C.) or more. Moreover, the patent official gazette discloses that the ambient temperature is provided less than the glass transition temperature Tg because the formed induced structure part (pattern) would be softened if it is at or more than the glass transition temperature Tg. That is, by the process at a temperature of or more than the glass transition temperature Tg, the processed portion is softened by the flowability and the flexibility so as to have the process traces vanish.

However, in the case the micro-fabrication by the laser beam is carried out to a plastic material to be processed by the method disclosed in the patent official gazette, the process limit of the diffraction poses a grave obstacle to the development of the nano/micro-fabrication.

On the other hand, recently, the nano/micro-fabrication utilizing the self organization behavior of the material of forming a three dimensional pattern has attracted greater attention (for example, G. F. Grom, D. J. Lockwood, J. P. McCaffrey, H. J. Labbe, P. M. Fauchet, B. White, J. Diener, D. Kovalev, F. Koch, and L. Tsybeskov, Nature 407, 385 (2000), B. Q. Wei, R. Vajtai, Y. Jung, J. Ward, R. Zhang, G. Ramanath, and P. M. Ajayan, Nature 416, 495 (2002), or the like). The self organization behavior is the phenomenon in which a molecular system or an atomic system spontaneously forms a certain design or pattern if the crystal growth is carried out while the crystal growth conditions such as the temperature, the pressure, the ambient gas and the growth time are precisely controlled.

However, in the process using a laser beam, investigation about the utilization of the self organization behavior has not been advanced in the present situation.

### DISCLOUSER OF INVENTION

From the background as mentioned above, an object of the present invention is to provide a novel micro-fabrication method for overcoming the process limit by the diffraction of the laser beam so as to allow the development to the nano/micro-fabrication utilizing the self organization behavior of the three-dimensional pattern.

In order to solve the problems, the present invention firstly provides a micro-fabrication method characterized by comprising the steps of applying a pulse laser beam to a plastic material to be processed exhibiting a glass phase transition by heating and having a heat-shrinkage to form laser-processed patterns on the surface of or inside the plastic material to be processed, and then heat-treating the plastic material to be processed at a temperature not lower than a glass transition temperature Tg to fine the formed patterns by heat-shrinkage.

Moreover, it secondly provides a micro-fabrication method characterized by using a plastic material to be processed wherein the formed laser-processed pattern is not lost by the heat treatment in the first invention.

Furthermore, it thirdly provides a micro-fabrication method characterized in that the formed laser-processed pattern is only fined by the heat treatment without its shape change in the first or second invention.

Moreover, it fourthly provides a micro-fabrication method characterized in that the temperature of the heat treatment T is Tg≦T≦Tg+200° C. in any one of the first to third inventions.

Furthermore, it fifthly provides a micro-fabrication method characterized in that the process is carried out while focusing a light beam so as to have the beam spot size of the pulse laser beam at the position for processing the plastic material to be processed to 100 nm to 10 μm in any one of the first to fourth inventions.

Moreover, it sixthly provides a micro-fabrication method characterized in that the light beam focusing to the plastic material to be processed of the pulse laser beam is carried out using an objective lens of 0.1 to 1.4 numerical aperture and 5 to 100 times magnification in the fifth invention.

According to the present invention, a novel micro-fabrication method for overcoming the process limit by the diffraction of the laser beam so as to allow the development to the nano/micro-fabrication utilizing the self organization behavior of the three-dimensional pattern is provided.

In general, it is a common knowledge that the processed pattern is softened and lost if a plastic material is heated to its glass transition temperature Tg or higher. However, according to a plastic material exhibiting the glass phase transition by heating and having the heat shrinkage, even in the case it is heated to the glass transition temperature Tg or higher after forming a laser-processed pattern inside or on the surface, only its dimension is made smaller while conserving the pattern shape without softening or losing the processed pattern. According to the present invention, by utilizing the phenomenon, not only a laser-processed pattern formation by a novel system is enabled but also a micro-fabrication beyond the process limit by the laser beam diffraction can be realized.

### BRIEF DESCRIPTION OF DRAWINGS

FIG. 1 is a view showing an example of the isotropic shrinkage within the in-plane direction of the sample by heating the sample with a picture drawn on a polystyrene film as the heat treatment at a temperature of or higher than the glass transition temperature, wherein (a) and (c) are the sample before the heat treatment, and (b) and (d) are the sample after the heat treatment, with (a) and (b) shown by the same scale and (c) and (d) by the same scale.

FIG. 2(a) is a view showing the normalized light intensity distribution at the focus of a floating objective lens having the numerical aperture NA=1.35, and FIG. 2(b) is a view showing the light intensity at the focus in the lateral optical coordinates and the axial optical coordinates.

FIG. 3 is a view showing the SEM side image of a polystyrene film, wherein (a) and (b) are of after recording, (c) and (d) are subjected to the heat treatment after recording, and (e) and (f) are recorded inside the material after the heat treatment.

FIG. 4(a) is a view obtained by plotting the experimental value and the theoretical value of the relationship between the diffraction efficiency and the diffraction angle of a diffraction grating formed in the polystyrene film, and FIG. 4(b) is a view showing an image of the structure of the diffraction grating (2×2 mm²) formed in the sample photographed with a white beam light reflection.

### BEST MODE FOR CARRYING OUT THE INVENTION

Hereinafter, the present invention will be explained in detail with reference to the preferred embodiments.

A micro-fabrication method of the present invention is characterized by comprising the steps of applying a pulse laser beam to a plastic material to be processed exhibiting a glass phase transition by heating and having a heat-shrinkage to form laser-processed patterns on the surface of or inside the plastic material to be processed, and then heat-treating the plastic material to be processed at a temperature not lower than a glass transition temperature Tg to fine the formed patterns by heat-shrinkage.

The present invention has been achieved by the investigation of the present inventors from the following viewpoints. That is, shaping of a plastic material is carried out commonly in the industrial field so as to provide various kinds of products including the products used in the everyday life. In the case of producing a plastic film (including a sheet), in general, the plastic material is quenched rapidly and pressured from the molten state so as to be a thin film. On the other hand, if a molten plastic is quenched gradually under the ambient pressure, the obtained plastic has a glassy structure with a drastically different nature with respect to the product obtained by rapid quenching. The stress relaxation of the plastic material shaped like a thin film can be applied for the nano/micro-fabrication work.

Then, the present inventors have elaborately discussed on whether a pattern preformed inside or on the surface of a plastic film (polystyrene film) can be resized (in the present specification, the resizing is referred to also as the “shape transition”). For the pattern formation, a pulse laser beam was used. Then, the present inventors have found out that the pattern is fined (scaled down) without the shape change by the heat treatment (annealing) at the glass transition temperature Tg of the polystyrene or higher exhibiting a glass phase transition and having a heat shrinkage with a pattern preformed with a pulse laser beam inside or on the surface so as to accomplish the present invention based on the knowledge.

The “pattern” in the present specification refers a structure constituting an assembly of gaps (voids) formed by applying a pulse laser beam or minute regions (spots) with a plastic material to be processed chemically modified.

The shape transition is the compression in the two dimensional direction (in-plane direction) and the expansion in the three dimensional direction perpendicular to the in-plane direction while conserving the volume as a whole, which can be considered as a heat activation process of relaxing the stress in the rapidly quenched and compressed plastic.

According to the polystyrene film used and investigated by the present inventors, with the X axis and the Y axis taken in the film in-plane direction and the Z axis in the direction perpendicular to the film surface, the shape transition was the shrinkage by about 2 times each in the X axis direction and the Y axis direction, and the expansion by about 4 times in the Z axis direction with the volume conserved as a whole.

The material to be processed as the subject of the micro-fabrication method of the present invention is a plastic material exhibiting a glass phase transition by heating and having a heat shrinkage as mentioned above. As such a material, various kinds of conventionally known materials such as a styrene based resin such as a polystyrene, an acrylonitrile-styrene copolymer, and an acrylonitrile-butadiene-styrene copolymer; a polyester based resin such as a polyethylene terephthalate; a methacrylate based resin such as a polymethyl methacrylate; a polyether ketone based resin such as a polyether ether ketone; a fluorine based resin such as a polytetrafluoroethylene; and a polyimide based resin such as a polyimide and a polyether imide can be used. Among these materials are those exhibiting and not exhibiting the heat shrinkage even in the case of the same kind. As to the heat shrinkage, it can be realized by the production process selection and a slight structure improvement. The heat shrinkage may either be isotropic or anisotropic in the plane. As to the plastic material to be processed, it is preferable to use one without losing the laser-processed pattern formed by the heat treatment.

The pattern formation by the laser beam with respect to the plastic material to be processed may be carried out by various methods including the method already proposed by the present inventors. In particular, a fabrication method using a femtosecond (pulse width in the 10⁻¹² to 10⁻¹⁵ second region) pulse laser beam is useful also for viewing the nano/micro-fabrication.

As to the pulse laser beam, it is preferable to have the beam spot size of 10 nm to 10 μm at a process position inside or on the surface of the plastic material to be processed, and it is more preferably 100 nm to 1 μm. With such a beam spot size, effective utilization for the nano/micro-fabrication can be expected.

The irradiation time of the pulse laser beam to the plastic material to be processed can be set at an appropriate value according to the process pattern, the laser beam intensity, the pulse duration, or the like, and it is about 0.1 to 10 seconds with respect to the same spot.

Light focusing of the pulse laser beam to the plastic material to be processed is carried out desirably using an objective lens of 0.1 to 1.4 numerical aperture and 5 to 100 times magnification, more preferably of 0.8 to 1.4 numerical aperture and 40 to 100 times magnification. Such an objective lens is preferable for the micro-fabrication of the nano/micrometer size.

The heat treatment after the formation of the laser-processed pattern to the plastic material to be processed is carried out with the process temperature T at the glass transition temperature Tg or higher of the plastic material to be processed. It is more preferably Tg≦T≦Tg+200° C., and further preferably Tg≦T≦Tg+50° C. The upper limit of the process temperature T of the heat treatment corresponds to the temperature not to generate the thermal decomposition of the plastic material to be processed by the heat treatment. In the case of a usually used general plastic material, the upper limit is Tg+200° C. The technique of the present invention utilizes the heat shrinkage of the plastic material to be processed so that generation of the heat shrinkage is a necessary condition for the formed pattern, and a heat treatment at a temperature of Tg or higher is sufficient. On the other hand, as the heat treatment temperature rises, the thermal decomposition of the plastic material to be processed is considered to be promoted. Therefore, the upper limit of the heat treatment temperature is Tg+200° C., and it is preferably Tg+50° C. If the heat treatment temperature T is lower than the glass transition temperature Tg, the fining process by the heat shrinkage of the formed pattern cannot be carried out. If it is Tg+200° C. or lower, it is preferable for avoiding the thermal decomposition of the plastic material to be processed while conserving the fining of the laser-processed pattern.

Moreover, as to the heat treatment, desired fining can be achieved by heating the plastic material to be processed in the atmosphere; however, it can be anticipated that the heating operation in the atmosphere often brings about deterioration by the oxidization of the plastic material to be processed. Therefore, the heat treatment is to be carried out preferably in the inert gas atmosphere such as a nitrogen and an argon, and more preferably a treatment in a vacuum carried out in a commercially available vacuum oven is desired. As to the heat treatment time, a time capable of sufficiently inducing the shrinkage is needed; however, by the heat treatment over a long time generates the risk of the deformation of the formed pattern by flowing of the polymer chain. Specifically, the heat treatment time is preferably from several seconds to 10 minutes.

For the laser process, a titanium sapphire laser, a semiconductor laser, a dye laser, or the like can be used.

Moreover, for the heat treatment after the laser-processed pattern formation, a device such as a vacuum oven can be used.

### EXAMPLES

Next, the present invention will be explained in further detail with reference to an example; however, the invention is not limited by the following example.

First, an example of the picture isotropic shrinkage in the film plane by heating a polystyrene film used as a recording material and a picture drawn thereon at the glass transition temperature Tg or higher will be described.

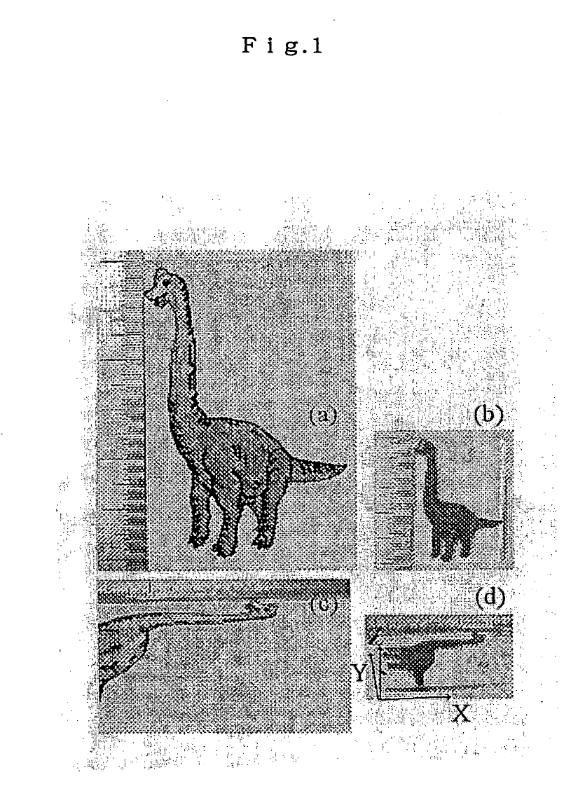

A4 size polystyrene film (manufactured by Ukita Corp., manufactured by Acrysunday Co., Ltd.) of 0.2 mm thickness was used as a recording material and cut by 65 mm vertically×50 mm laterally. After drawing a picture with an oil based marker on the polystyrene film as shown in FIG. 1(a) so as to provide a sample, a heat treatment was carried out at 130° C. for 2 minutes. The glass transition temperature Tg of the polystyrene is 100° C. The states of the sample before and after the heat treatment are each shown in (a) and (c), and (b) and (d) of FIG. 1. (a) and (c) of FIG. 1 are of the same scale and (c) and (d) of FIG. 1 are of the same scale, with the smallest division of 0.5 mm.

With the heat treatment at a temperature higher than the glass transition temperature Tg of the polystyrene, the sample was shrunk by about 2.1 times laterally and vertically in the plane (X direction and Y direction) (FIG. 1(b)), and it was stretched (expanded) by about 4.4 times in the direction perpendicular to the in-plane (Z direction) (FIG. 1(d)).

The volume change by the shape transition was V_{after}/V_{before}=(1/x)·(1/y)·(z/1)≈99.8%, where x, y and z represent the dimensions after the shape transition via fractions of the corresponding dimensions before the shape transition. It was observed that the dimension became smaller by 12% after the heat treatment in the case the thickness of the used polystyrene film was doubled (0.4 mm). The degree of the change was slightly dependent on the heating temperature and the heating time.

Next, an example of the resizing of the pattern recorded inside the polystyrene by a femtosecond pulse laser beam utilizing the phenomenon, that is, the shape transition will be described.

The size of the voxel (3D pixel) (volume element) recorded by the femtosecond pulse laser beam can be made smaller by the cross section of the focus determined by the law of diffraction and the aberration. Then, the change induced by the shape transition of the formed pattern of the voxel can be traced by the submicrometer scale.

As the femtosecond pulse laser device, a laser oscillator (Tsunami; manufactured by Spectra Physics Inc.) comprising a regenerative amplifier operated at 800 nm wavelength (Spitfire; manufactured by Spectra Physics Inc.) and a microscope (IX70; manufactured by Olympus Corporation) was used. Using a PZT stage (PI; manufactured by Polytec Corp.), the sample (polystyrene film; thickness 0.2 mm; manufactured by Acrysunday Co., Ltd.) was scanned according to a pre-programmed process pattern. The stability of the pulse laser was about 3% (root mean squared (rms) value). The laser beam was focused inside the sample by using 100 times magnification microscope objective lens (Uplan APO100^{x}) set at a 1.35 numerical aperture (NA). The sample and the objective lens were contacted using an immersion oil. Since the refractive indices of the immersion oil and the polystyrene were approximately the same (n≈1.52), the aberration can be minimized. The actual diameter of the focus depends on the truncation ratio of the incident beam at the entrance of the objective lens and a beam's evenness, and can be evaluated precisely.

Pulse energy was directly measured at the irradiation point by an electric power meter (OPHIR; manufactured by Laserstar Corp.) using a solid liquid immersion lens (SIL). In order to calculate the recording light intensity at the focus, the pulse duration at the focus was measured by the Grenouille method (manufactured by Swamp Optics LLC.), and the pulse duration [full width at half maximum (FWHM)] was retrieved by the frequency-resolved optical gate (FROG) algorithm (manufactured by Femtosecond Technologies Corp.). The pulse duration at the focus was 225±20 femtoseconds at a FROG error of less than 2% (more details can be found in S. Juodkazis et al., Prc. SPIE, Advanced Laser Technologies ALT-02, 5147 vol., 226-235, (2003)).

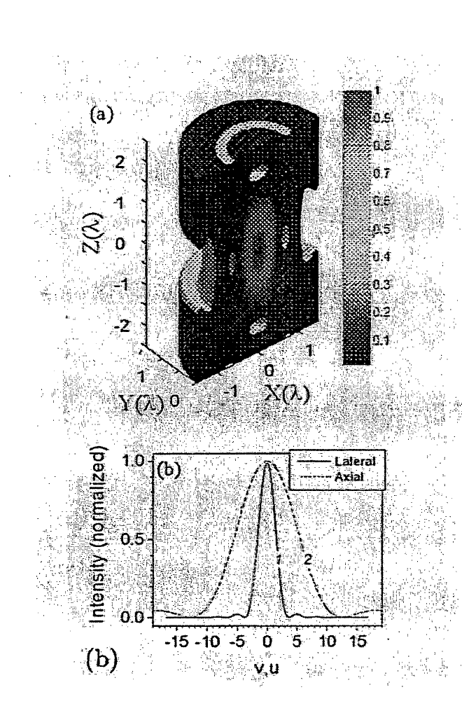

The pulse focus, that is, the spatial dimension of the “light pen” used for recording was close to that by the Scalar Debye theory, and the focus without the aberration in the refractive index n=1.5 medium was calculated (axial (Z direction)×lateral (X direction))≈(0.87×0.29) [μm²] (FWHM). Here, the apodization function was chosen to obey the sine condition. This technique is standard for an aplanatic objective lens. The light intensity at the focus was calculated from the point spread function (PSF). The point spread function is for determining the electric field amplitude at the focus. For a focus of a high numerical aperture lens, the point spread function can be found from the Debye theory, and is given by the following formula:

$$E ( v , u ) = \frac{2 π i}{λ} exp ( - ikz ) {\int }_{0}^{α} P ( θ ) {J}_{0} ( \frac{v sin ( θ )}{sin ( α )} ) \times exp ( \frac{iu {sin}^{2} ( θ / 2 )}{2 {sin}^{2} ( α / 2 )} ) sin ( θ ) d θ \qquad ( 1 )$$

wherein v=kr·sin(α) and u=4 kz·sin²(α/2) are the lateral (X direction) and axial (Z direction) optical coordinates, k=2π/λ is the wave number defined by the wavelength λ at the focus, J₀ is the zero order Bessel function of the first kind, and α is the half-cone angle of the focus. The numerical aperture in material with a refractive index n is NA=n·sin (α), and P(θ)=√cos(θ) is the apodization function that satisfies the sine condition (the aplanar focusing). The result of the calculation by the formula (1) is plotted in FIG. 2. FIG. 2(a) represents the normalized intensity distribution I=¦E (v, u)¦² (formula (1)) at the focus of the aplanatic objective lens of a numerical aperture NA=1.35, with the lateral axis shown by the unit of the wavelength λ, and the intensity threshold of the isosurface (shown in gray) set at 1%. FIG. 2(b) is a graph obtained by plotting the normalized intensity in the lateral direction (X direction) and the axial direction (Z direction). FIG. 2 shows that the dimension of the focus in the axial direction (Z direction) is longer by about 2.95 times than the size of the focal spot in the lateral direction (X direction) in the present experimental condition, that is, FWHM of the aspect ratio fₐ≈3.

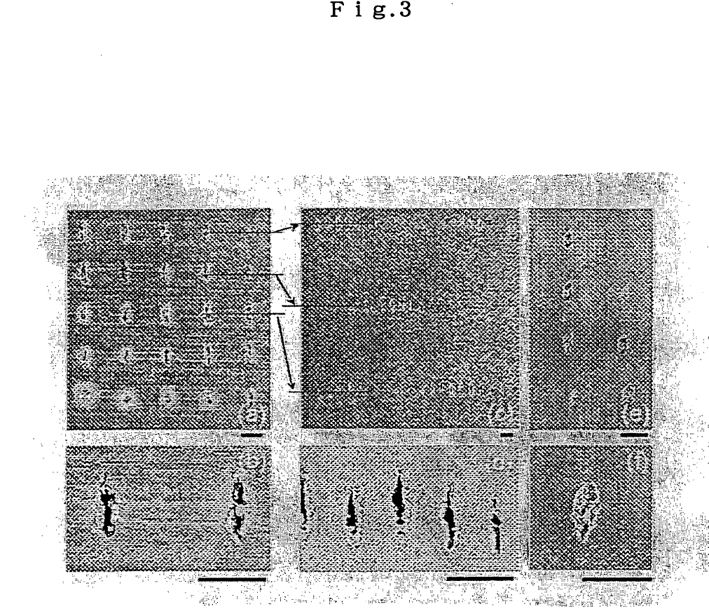

The dimensions of the (gap) void had been optically recorded by a single pulse laser beam in the polystyrene were measured by an electric field radiation scanning electron microscope (SEM) (JSM-6700FT; manufactured by JEOL Ltd.). After cutting the sample with a bio microtome (UTC; manufactured by Ultracut Corp.; it can cut a cartilage material without distortion of the internal features), a several nanometer thickness Pt film was deposited, and it was observed with the SEM. For the reference, a pulse laser beam was irradiated to observe the typical morphology and size of the voxel recorded by a femtosecond pulse laser. These results are summarized in FIG. 3. FIG. 3 is a SEM side-view image of the 0.2 mm thickness polystyrene film (manufactured by Acrysunday Co., Ltd.), wherein (a) and (b) are of after recording, (c) and (d) are with the heat treatment after recording, and (e) and (f) are recorded on the material after the heat treatment. The recording light intensity was about 1.25×I_{LIDT} (LIDT denotes the light-induced damage threshold), and the heat treatment was carried out at 135° C. for 100 seconds in the atmosphere. The scale bar in the figure represents 1 μm. Here, the lateral cross section along the recording beam propagation was examined. Voids were formed at the focus. The voids were surrounded by a high density clad of a transited material, which was observed inside the sample using a polymethyl methacrylate as reported in the article (K. Yamasaki et al., Appl. Phys. A 77, 371 (2003)) by the present inventors.

The mechanism of the void formation by a single pulse laser beam is as follows. At the time of forming a highly conductive (metallic) state of material by the dielectric breakdown during the passage of the pulse front, the subsequent pulse energy is absorbed at the focus within the surface skin-depth of the material. The absorbed energy becomes larger than the bond energy so as to be sufficient for forming a high pressure gas phase plasma, and as a result, the gaps are formed.

It was observed that the shrinkage in the in-plane direction and the expansion in the axial direction of the polystyrene sample precisely follow the results of the naked eye observation [FIG. 3(a) to (c), transition marked by arrows]. That is, the same ratio of resizing was observed at the outer perimeter of the sample. The dimensions of the voids recorded in the polystyrene by the beam intensity 1.25×I_{LIDT}, which is close to the light-induced damage threshold was approximately 0.25 μm in diameter and approximately 1 μm in length. The light-induced damage threshold in term of the pulse energy was 8.5 nj, the fluence was 4.5 J/cm², and the irradiance was 20 TW/cm² (FWHM). It was confirmed that the shape transition does not dramatically change the cross section of the voids [FIG. 3(b) and (d)]. On the other hand, the intra-void distance follows the macroscopic scaling precisely, which can be observed also by the naked eyes (FIG. 1). Since the conservation of the volume and the light transmittance unchanged by the shape transition were confirmed (less than 10% error), it is presumed that neither the refractive index nor the light absorption coefficient of the material was influenced. This means that the density remained unchanged before and after the shape transition. Therefore, it is beneficial to compare the dimensions of the voids recorded in the polystyrene without the heat treatment and the polystyrene after the heat treatment. The polystyrene after the heat treatment was recorded [FIG. 3(c) and (f)] so as to find that it was a voxel (the corresponding aspect ratio is fₐ=2.6) having an internal void of 0.92×0.36 [μm] cross section at 10 μm depth when the pulse energy was approximately 1.25×I_{LIDT}. The dimensions of the recorded voxels were relatively close to the focal size derived from the Debye theory (FIG. 2). On the other hand, the aspect ratio of the void recorded in the polystyrene was fₐ=4 [FIG. 3(b)], and rose to 4.7 after the heat treatment [FIG. 3(d)]. These values are considerably larger than the expected aspect ratio of the focal spot.

The fₐ values of the voids recorded in the polystyrene before the heat treatment being relatively large can be explained by local heating during the dielectric breakdown. That is, local generation of the shape transition can be explained thereby. It is noteworthy that the recording power per pulse at the light-induced damage threshold is just 38 KW, which is much lower than the critical power of the self-focusing which is about 1 to 2 MW for glassy material. This is the reason why such a laser recording can be considered direct laser writing. That is, it can be expected that the photo-modification of the material closely follows the proportions of the light intensity distribution at focus. The aspect ratio of the voids being slightly larger than the ideal focal spot can be caused in part by aberration; however, but not by the nonlinear effects of the pulse propagation.

Moreover, in the example of the present invention, by scanning with the femtosecond pulse laser beam using the shape transition process, the resizing of the diffraction grating formed in the polystyrene film (thickness 0.2 mm; manufactured by Acrysunday Co., Ltd.) was carried out.

The diffraction grating in the polystyrene was formed under the following conditions.

Pulse laser beam

| | |
|---|---|
| Wavelength: | 800 nm |
| Pulse duration: | 225 ± 20 femtosecond |
| Light intensity; | 25 TW/cm² |

Objective lens

| | |
|---|---|
| Numerical aperture NA: | 1.35 |
| Magnification: | 100 times |

Size of the focal spot

| | |
|---|---|
| Diameter: | approximately 0.3 μm |
| Axial length: | 1 μm |

Diffraction grating before the heat treatment

| | |
|---|---|
| Shape: | 10-slit grating |
| Grating period: | 2.5 μm |

Moreover, the heat treatment of the polystyrene film with the diffraction grating formed was carried out at 130° C. for 120 seconds.

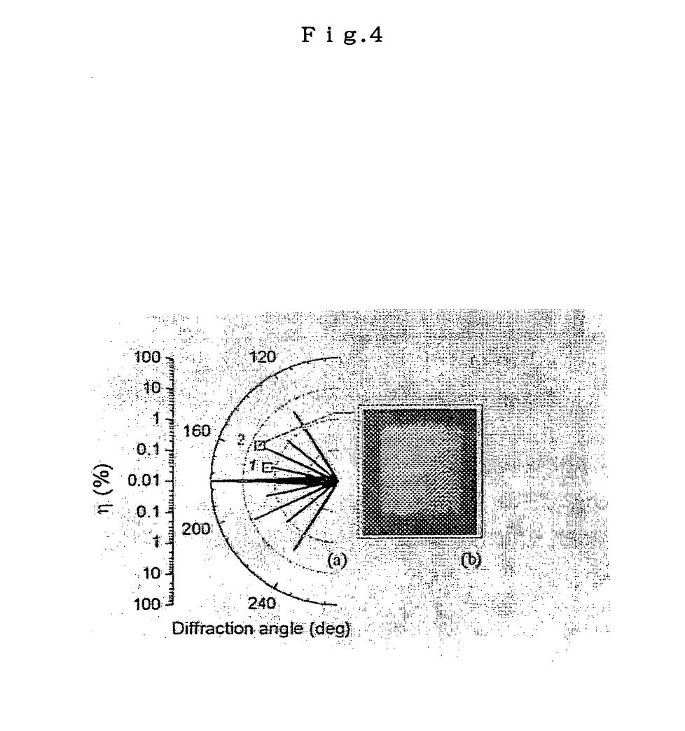

The zero order and the first order diffraction intensity of the heat-treated sample was measured. FIG. 4(a) represents the relationship between the diffraction efficiency η (square) by this experiment and the diffraction efficiency η (curve) by the calculation, and the diffraction angle θ. The diffraction efficiency of the sample immediately after the formation of the diffraction grating (without heat treatment) is shown in the figure by (1), and the diffraction efficiency of the diffraction grating of the sample with the heat treatment is shown in the figure by (2). The experiment value η was calculated by η=I₁/(I₁+I₀) [wherein I₀, I₁ are zero order and first order diffraction intensities]. FIG. 4(b) is the structure of the diffraction grating 2×2 mm² formed in the sample photographed by the white beam light reflection. The diffraction efficiency was calculated as that of a multi-slit by the following formula:

$$\frac{I}{{I}_{i}} = {( \frac{sin β}{β} )}^{2} {( \frac{sin ( N γ )}{N sin γ} )}^{2} \qquad ( 2 )$$

wherein Iᵢ and I are the intensitie of the incident and trasmitted ight, N is the number of the slits, the phase parameters β=(½)kb·sin θ and γ=(½)kb·sin θ are determined by the opeing length b, the period h, the wavevector k=2π/λ, and the wavelength λ and the diffraction angle θ. Since the formula (2) describes the angular dependence of the diffraction efficiency for a diffraction grating, as to the theoretical simulation, it can be considered as a quantitative model only when it is applied to a diffraction from the diffraction grating recorded in polystyrene. Shrinkage of a 2.5 μM-period with an approximately 0.3 μm void at the core at the time of the shape transition was confirmed qualitatively by measuring the diffraction efficiency (FIG. 4) at the time of calculating the theoretical curve by the formula (2) for a 10-slit grating. As it is seen here, the two-fold reduction of the grating period increases the diffraction efficiency, and as it is predicted from the theory, the diffraction angle was higher by approximately two-fold. According to the experiment performed on a low-cost polystyrene, the principle was confirmed so as to show that the shape transition is useful for the application to the photonics.

As it has been reported by the present inventors preliminarily, the femtosecond laser fabrication is capable of recording a void and a channel having about 0.4 μm cross sectional shape in a polymethyl methacrylate (K. Yamasaki et al., Appl. Phys. A 77, 371 (2003)). Therefore, it can be expected that the nano-structure of a polymer having about 100 nm featrure size can be reachable by the femtosecond micro-fabrication. Additionally, the shape transition by the present invention is expected to further enable deformation of a recorded void pattern.

For example as it has been heretofore explained in detail, by the heat treatment at a temperature of the glass transition temperature or higher of polystyrene, the dimension of the pattern recorded in the polystyrene can be changed. It was confirmed that the void dimension recorded in the polystyrene was not substantially changed after the shape transition. This phenomenon can be adopted for the nano/micro-fabrication structuration of a plastic material.

1. A micro-fabrication method which comprises applying a pulse laser beam to a plastic material to be processed exhibiting a glass phase transition by heating and having a heat-shrinkage to form laser-processed patterns on the surface of or in the above plastic material to be processed, and then heat-treating the plastic material to be processed at a temperature not lower than a glass transition temperature Tg to fine the formed patterns by heat-shrinkage.

2. The micro-fabrication method according to claim 1, which comprises using a plastic material to be processed wherein the formed laser-processed pattern is not lost by the heat treatment.

3. The micro-fabrication method according to claim 1 wherein the formed laser-processed pattern is only fined by the heat treatment without its shape change.

4. The micro-fabrication method according to claim 1 wherein the temperature of the heat treatment T is Tg≦T≦Tg+200° C.

5. The micro-fabrication method according to claim 1 wherein the process is carried out while focusing a light beam so as to have the beam spot size of the pulse laser beam at the position for processing the plastic material to be processed to 100 nm to 10 μm.

6. The micro-fabrication method according to claim 5, wherein the light beam focusing to the plastic material to be processed of the pulse laser beam is carried out using an objective lens of 0.1 to 1.4 numerical aperture and 5 to 100 times magnification.
